(19) United States
(12) Patent Application Publication
(10) Pub. No.: US 2023/0089680 A1
(43) Pub. Date: Mar. 23, 2023

(54) Systems and Methods Using Cameras on Smartphones to Provide Provably Trusted and Authentic Photographs of Persons, Locations, Items, and Property

(71) Applicant: Mahboud ZABETIAN, Orinda, CA (US)

(72) Inventor: Mahboud ZABETIAN, Orinda, CA (US)

(21) Appl. No.: 17/950,459

(22) Filed: Sep. 22, 2022

Related U.S. Application Data
(60) Provisional application No. 63/247,064, filed on Sep. 22, 2021.

(51) Int. Cl. G06Q 30/00; G06Q 30/06

(52) U.S. Cl. CPC G06Q 30/0185; G06Q 30/0609

(57) ABSTRACT

This invention allows users with smartphones to make a big dent in the problem of fake images or altered images. Recipients of images from these users can verify that the images were taken by a user, for a specific purpose or person, at a certain time, without any alteration, and that the image is not one taken off of another site, and/or altered to misrepresent.

### CROSS REFERENCE TO RELATED APPLICATIONS

This application claims the benefit of U.S. Provisional Application No. 63/247,064, entitled “Systems and methods using cameras on smartphones to provide provably trusted and authentic photographs of persons, locations, items, and property” and filed on Sep. 22, 2021, which is incorporated herein by reference in its entirety for all purposes.

### FIELD OF THE INVENTION

This invention relates to the creation of photographs on a smartphone, in a manner which allows for the verification of the authenticity, purpose, and temporality of those photographs.

### BACKGROUND OF THE INVENTION

Many online services today utilize photographs to identify a person, a location or a property. For example, many internet sites use a thumbnail of a user for identification purposes. Apartment renting sites, or vacation rental sites, use photographs of the exterior and interior of a location to represent what the browsing user could rent. Dating sites make available the self-uploaded photographs of users in order for other users to select suitable matches. Auction sites allow for the upload of images of items for sale, representing what the bidders are bidding on.

However, the technology available today makes it very simple to use any photograph and present the photograph as being authentic. This shortcoming is misused or even abused, sometimes with negligible consequences, and other times with very significant damage, monetary loss and mental anguish. Malicious users or scammers, purporting to rent out an apartment or property, have been known to upload photographs of a different apartment, one the malicious users do not own or have any rights to, as the property available for rent. Renters assume the photographs are real and upon arrival at the location, the renters have found the rental property paid for, has no semblance to the pictures of the different apartment viewed before arrival. In some cases, the renters arrive, finding the rental property as described, but unavailable, as the renters had rented from malicious user that had no rights to rent the property. The scammers merely “steal” photographs found from legitimate rental sites and post the photographs as their own. Photographs of collectibles and valuables on an auction page, are obtained from other auction's websites, and bidders may be fooled into bidding on something shown in the photograph that is inferior or non-existent. While auction sites try to police this activity by providing escrow and proof-of-delivery, such procedures are imperfect and cumbersome. Photographs of a valuable item being auctioned, could be lifted off and utilized maliciously in other fake auctions in a scam to impact the sale price of that real item. While bidders genuinely interested get confused and bid on the fake auction, the scammers can win the real item at a lower price.

Dating site participants often complain that images that are posted by purportedly real people on a site, do not represent those people due to alterations and/or age of the photograph. Photographs from years ago, or photographs that have been retouched, represent a faulty image of the prospective dates. Dating sites are inundated with images of women and men that have been culled or stolen from other sites, and fake profiles are created using those images in order to trick people into brief online romances that end with scams. In some scams, money is extracted for the purchase of airline tickets for a date that never arrives. Others lead to down-and-out stories of poor health and impending surgeries, again with a goal of extracting money from the legitimate dating site user.

Journalism outlets rely on real, untampered and untouched photographs. Many photographs are stolen from other outlets and resold, or the photographs are altered to tell a different story. The lack of trusted photographs is also a restricting factor in the adoption of user supplied photographs for official use. For example, if governmental agencies could ascertain the authenticity of a photograph and the date of the creation of that photograph, then users with an authentic photograph could merely send in the photograph instead of going into an agency to get a new driver's license, identification card, or passport.

Therefore, there exists a need in the art for a system and method for authenticating pictures or images, that provides security that is both easy to use and hard to defeat

### SUMMARY OF THE INVENTION

A preferred embodiment of the invention provides a system which takes an image directly from a smartphone's camera and timestamps that image, using a cryptographic mechanism that utilizes an external site, and also preferably attaches optional tags such as usernames, email addresses, property addresses and GPS locations, auction and listing IDs, or even simple messages, that will be indelibly attached to those photographs. Any recipient of one of these photographs can easily use the verification feature of the system to verify a photograph, the time the photograph was taken, the purpose the photograph was taken for, or who the photograph was intended for.

This system addresses the “fake image” or “altered image” problem and produces photographs that can be trusted as being authentic, and trustworthy. A preferred embodiment the invention includes software, an image application, that utilizes common smartphones, such as an Apple iOS iPhone that collectively provide the following features.

A direct channel is provided from the application to the smartphone camera for image or video acquisition, with no meaningful alteration of the image before acquisition by the application. Note both photographs and videos are also referred to as images. The application only uses that image, or similarly directly captured and internally, securely stored images. There is no allowance to import or to use images stored or acquired, outside the application. Optionally the application associates GPS location information to the image, which is directly extracted from the smartphone's geolocation system.

The image is timestamped utilizing a process such as described in United States patent application (Ser. No. 16/903,332), incorporated herein by reference. The image application stores the image, along with an unalterable timestamp, in a private internal library of images and allows users to select that photograph, immediately or at a later date, and then requires the user to provide any or all of the following metadata: listing ID, location address, username, email address, and many other tags or descriptive texts. The image application preferably allows for the image's GPS data to be cloaked, or generalized, if GPS is being provided along with the final image.

The image application optionally employs identity authentication using passwords and/or biometrics that are provided by the smartphone and adds to the metadata to the final image. Cryptographic fingerprinting of the images, with and without the metadata embedded, is conducted as required. An identifying token from the smartphone is preferably employed to verify that the smartphone has not been tampered with and is running unaltered software. This two-way token is generated by a token request from an external server. This step also ensures that the trusted image application is being used to capture and submit photographs to the system, and not some other software that is masquerading as the image application. Transmission of a fingerprint, and optionally the selected metadata, and the identifying token, to the external system is conducted in a secure manner, using cryptographic mechanisms, and using pinned certificates or similar.

After receiving confirmation and other details from the external system, the image application will then provide a final image, with appropriate metadata, and accompanying text and will again obtain a timestamp. This final image is now tamperproof. The tamperproof image can then be transmitted to the desired destinations by the user, without the need of additional limitations or constraints. The transmission to the destination is preferably conducted by the usual means, such as SMS, email, HTTP upload, FTP, etc. Management of images and the metadata by the image application, locally on the device and optionally in the cloud, is in a protected and unalterable manner. Also, a history and library of created images and associated metadata is also constructed. There is an option to reuse images being managed, with the original timestamp and geolocation, but with new metadata. One could use the same photograph for a different dating site, or the same photographs of an apartment, for a different listing on another site.

Most functions occur within the image application, except for what is provided by the external system, described below, which is also a preferred embodiment of this invention. When the image application sends the fingerprint and associated metadata, or hash thereof, to the external site, the fingerprint, and optionally the metadata, are inserted into an unalterable chronologically ordered ledger. The time of the transaction is recorded as part of the insertion operation. The fingerprint and the insertion address, and, possibly, the metadata, is saved in the external system to be used for verification purposes. Information is sent back to the image application indicating the time of recording into the chronologically ordered ledger, and any necessary status information.

Another preferred embodiment also covers a related external service, which allows for the verification and authentication of these images. This service can directly take images with the right metadata embedded, as an upload, and verify the images. Or the server can take the URL to an image and verify that directly. Alternatively, if the image is emailed or SMSed to a user, that user could export that image to the image application described above and initiate an authentication of that image using the external service. This mechanism will not require the uploading of the entire image to the server, but merely the fingerprint, and associated metadata.

### BRIEF DESCRIPTION OF THE DRAWINGS

The disclosure may be more completely understood in consideration of the following description of various illustrative embodiments in connection with the accompanying drawings.

FIG. 1 shows an overall schematic of an image transport system for sending authentic images from a smartphone, in accordance with a preferred embodiment of the invention.

FIG. 2 shows a schematic view of the smartphone of FIG. 1.

FIG. 3 shows an overall flowchart showing a method of sending authentic images in accordance with a preferred embodiment of the invention.

FIG. 4 shows a flow chart of a method of verifying the identification number of the smartphone of FIG. 1.

FIG. 5 shows a flow chart of a method of displaying when an image has been authenticated by the system of FIG. 1.

### DETAILED DESCRIPTION OF THE INVENTION

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

As used in this specification and the appended claims, the singular forms “a”, “an” and “the” include plural referents unless the content clearly dictates otherwise. As used in this specification and the appended claims, the term “or” is generally employed in its sense including “and/or” unless the content clearly dictates otherwise.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range.

The following terms are employed when describing preferred embodiments of the invention and are defined as follows:

An “app” or “application” running on a smartphone, or other computing device with a secure OS and a camera, is software operating on the smartphone as part of the larger multi-node system.

A “trusted system”, is a combination of a central system that communicates with the application, and also, either contains a trust mechanism, or communicates with a trust mechanism, pushing the greater task of trust onto a third party.

A “fingerprint” is a cryptographic hash, which can uniquely identify an image, and distinguish the image from any other image, even a very similar one that has been modified, even if that modification is a single digital bit, or the deletion or addition of a single bit or more.

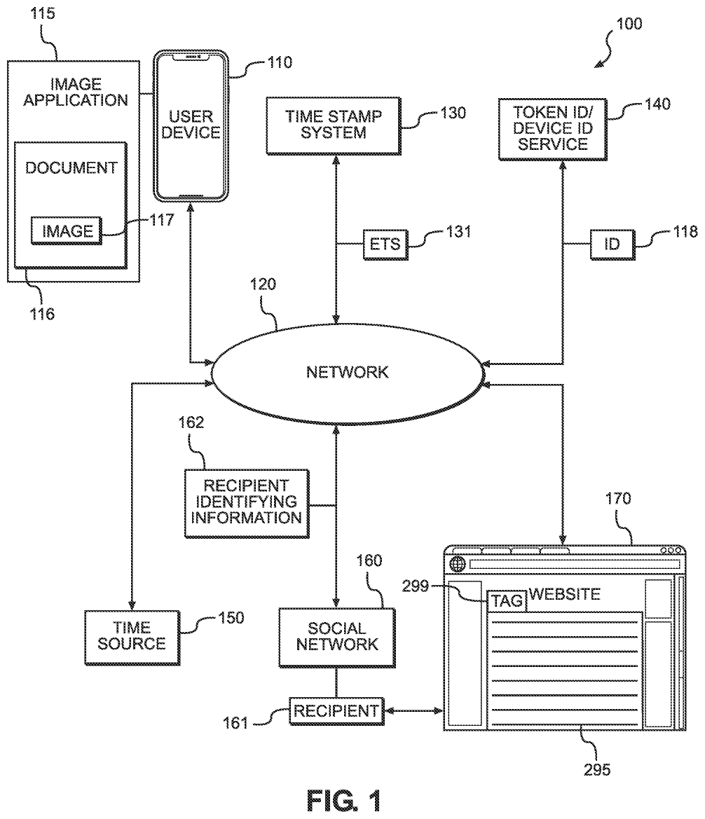

In FIG. 1, there is shown an overall image transport system 100 for using cameras on smartphones to provide provably trusted and authentic photographs of persons, locations, items, and property. The system 100 includes a user device 110, which is preferably a smartphone, such as an IPHONE or an ANDROID type smartphone. The user device 110 runs an image application 115, which processes electronic documents 116, that contains image 117. Electronic document 116, and image 117 are preferably within image application 115 which creates the electronic document 116 and image 117 and timestamps the image 117 as described below. The user device 110 is connected to a communications network 120 such a cellular network or the internet. The communications network 120 connects several other devices to each other and to the user device 110. An authentication server 130 is connected to the communications network 120. Upon receiving a request, the authentication server 130 will provide a verifiable timestamp 131 for the electronic document 116. A device ID verification service 140 is also connected to the communications network 120 and provides confirmation of a device ID 118 for the user device 110. A time source 150 is connected to the communications network 120 to provide an accurate time. Preferably time source 150 is an atomic clock. A social network 160 is connected to the communications network 120 and preferably provides access to numerous members, such as recipient 161 on the social network 160, preferably through a service represented by website 170. The service will process the document 116 and display if the document 116 is valid or not by tag 299. Recipient identifying information 162 is provided from the recipient 161 through the network 120.

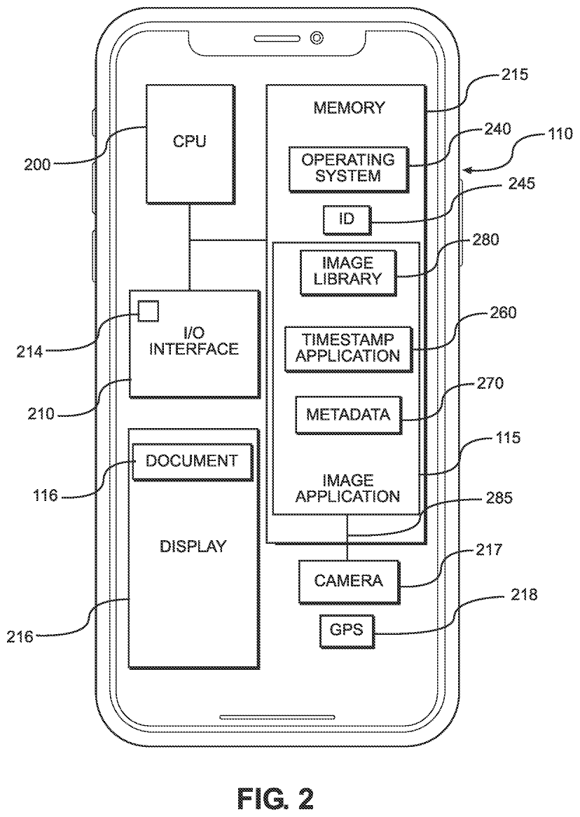

FIG. 2 is directed to the user device 110. The user device 110, which is preferably a smartphone, has a processor with a central processing unit 200 connected to an input/output interface 210 which includes a transceiver and has at least one button 214 and a memory 215. The term “processor” may refer to any suitable hardware and/or software system, mechanism, or component that processes data, signals, or other information. A processor may include a system with a general-purpose central processing unit (CPU), such as the central processing unit 200, multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

The input/output interface 210 can provide functions to enable interfacing the user device 110 with other systems and devices. For example, network communication devices, storage devices (e.g., memory and/or database), and input/output devices can communicate via the input/output interface 210. The memory 215 and may be any suitable processor-readable storage medium, e.g., random access memory (RAM), read-only memory (ROM), electrical erasable read-only memory (EEPROM), flash memory, etc., suitable for storing instructions for execution by the central processing unit 200, and located separate therefrom

A display 216, displays images and information to a user, such as document 116 after verification. A camera 217 for taking images and a GPS sensor 218 for providing location information are also arranged in the user device 110. The memory 215 includes an operating system 240, a timestamp application 260, a storage area for metadata 270, an image library 280, the image application 115. The operating system 240 is preferably a standard operating system that controls operation of the user device 110. The timestamp application 260 is provided to timestamp documents with the verifiable timestamp 131. The metadata 270 is for storing information regarding the electronic document 116. The image library 280 is able to store images, such as image 117, and the image application 115. The image application 115 has a secure direct channel 285 extending to the camera 217 and the image library 280. Indeed, image application 115 encompasses the timestamp application 260, the storage area for metadata 270, and the image library 280 to allow secure transmission of information between these features, all within image application 115.

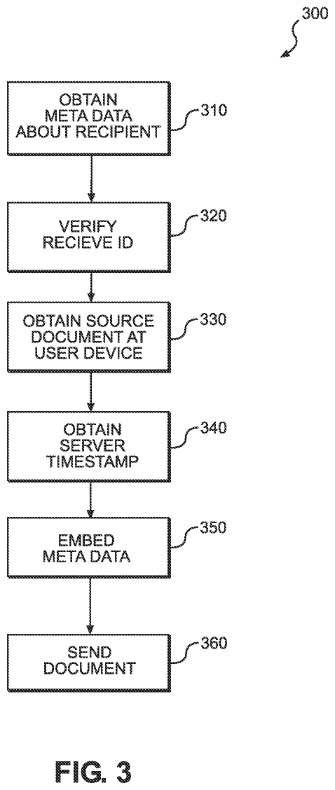

FIG. 3 shows the overall process 300 for authenticating electronic images 117 sent to the recipient 161. The process includes obtaining at 310, recipient identifying metadata information 162 about the recipient 161. Next the process 300 includes generating, at 320, a unique identifier value such as device token or device ID 118, from the user device 110, identifying the user device 110. At 330, obtaining, prior to any modification, the original electronic document 116 containing an image 117, directly from the sensor or cameras 217 on the user device 110 or from the secure library 280 on the user device 110 and excluding images from any other source. Next, at 340, process 300 includes receiving, by a timestamp and authentication server 130, the verifiable timestamp 131 that indicates the time the image 117 was created. Preferably, multiple timestamps are employed one for when the photograph is taken and one for each time the photograph has new metadata associated and then transmitted, which is needed so that the verification can double check a trusted ordered ledger to make sure that a picture with whatever metadata, is valid. For example, if a user takes a picture of himself, this picture gets timestamped so the original time the picture was taken is recorded. Then when the user sends the picture, over the next two weeks, to a dozen dating sites, each submission will have unique own metadata such as adding the username on all these sites, “handsome-devil666”, “total-stud-321”, “sad_and_lonely_5” . . . . This metadata needs to be timestamped (entered into a ledger), to allow a verification system to check the metadata. Verification software then does two things: 1. Checks to make sure that the metadata is valid, and when the metadata was added to the image, and 2. Returns the original image timestamp which should be within seconds of when it was taken or if there was a network issue, as soon thereafter when network connection succeeds. If only one timestamp is provided in total, then the fact that the image and the metadata were added on a certain date is protected, but there is no second protection on the photograph's creation time, and one could not reliably prove that the photo had been taken much earlier than what metadata timestamp states.

Then, at step 350, the process 330 includes embedding the recipient identifying information 162, the unique identifier value, device token or device ID 118, and the verifiable timestamp 131 into the electronic document 116 to generate a provably trusted electronic document 295; and sending the provably trusted electronic document to the recipient 161.

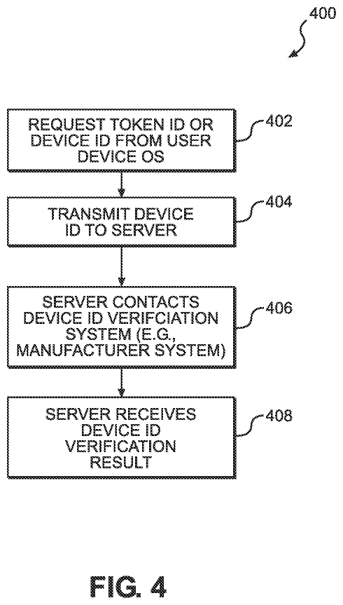

The process of FIG. 4 includes a more specific way to provide a device token or device ID, where the image application requests the user device token or device ID 118 from the user device operating system (OS) 240 at step 402. The user device operating system 240 can include an interface call that provides the device token or device ID 118 to the agent application when requested. The device ID 118 can include an IMEI number, a MAC address, an identifier generated by the device operating system based on one or more hardware identifiers (e.g., IMEI, MAC, QUID, etc.), or another suitable device identifier (e.g., secure, unique identifier). The device ID is only valid for the image application 115, not other applications from other third parties. Processing continues to 404.

At 404, the user device 110 transmits the device token or device ID 118 to the timestamp/authentication server 130. The device token or device ID 118 can be sent separately or as part of a message including other data items such as the hash value. Processing continues to 406.

At 406, the server 130 contacts a device ID verification service 140 to verify device token or device ID 118. For example, a device or operating system manufacturer such as Apple or Google may provide a device ID verification service 140. The authentication server 130 can contact the device ID verification service 140 and provide device token or device ID 118 and optionally other information relevant for device token or device ID verification. Processing continues to 408.

At 408, the authentication server 130 receives a device ID verification result from the device ID verification service 140 indicating whether device token or device ID is verified or not. If validated the image application 115 and operating system 240 are considered authentic, if not the server 130 will mark the device 110 as inauthentic and reject the timestamp request.

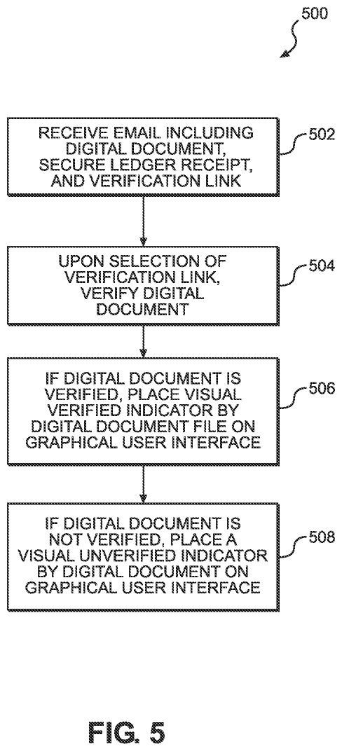

FIG. 5 is a flowchart of an example method to timestamp and authenticate electronic documents in accordance with some implementations. Processing begins at 502, where an email is received that includes a digital document, a secure ledger receipt (or portion thereof), and a verification link (e.g., a URL to connect to a timestamp/authentication server). Processing continues to 504.

At 504, upon selection of the verify link, the user device 110 establishes a connection with the timestamp/authentication server 130 to verify the digital document 116. The user device 110 can send the digital document 116 or a fingerprint/hash of the document and the secure ledger receipt (or portion thereof) to the timestamp/authentication server 130. The authentication server 130 can perform an authentication and return an authentication result to the user device 110. Processing continues to 506.

At 506, if the authentication result is that the digital document is authentic, then a visual verification indicator or visible tag 299 (e.g., a graphical symbol such as a green check mark or other indicium) is displayed near the digital document 295 in a graphical user interface on display 216 to provide a visual indication of authentication.

At 508, if the digital document 116 is not verified, a visual “not verified” indicator (e.g., a red X or other indicium indicating non-verification) is placed near the digital document in a graphical user interface to provide a visual indication of not authenticated status.

One or more methods described herein (e.g., the methods shown in FIGS. 3-5) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. field-programmable gate array (FPGA), complex programmable logic device), general purpose processors, graphics processing units (or GPUs) application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device, laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural, or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

In order to create a trusted image in accordance with another preferred embodiment of the invention, the following steps are performed. The user will utilize the image application 115 in similar manner as a traditional camera application. Once the subject is framed on the screen, the button 214 is tapped to capture the image 117. The image application 115 acquires the image 117 directly from the smartphone camera 217, without any opportunity for alteration. The image application 115 accesses the camera 217 through an OS API in the operating system 240 that is secure and provided by the OS manufacturer, with no third-party software or hardware in the path 285. The application 115 thus has the image 117 and sends the fingerprint for time stamping, and then stores the image 117 and that fingerprint in an “album” or “gallery” or “Library” 280, that is maintained in the image application 115 or makes that image 117 immediately available for sending. Users can select an image from that album library and then add metadata to that image, in the process of making it ready for sending. The application 115 will then take the hash of the image 117 and the hash of the metadata 270 and get those timestamped together. The image 117 will be timestamped, by sending the image's hash to the external system, authentication server 130. Meanwhile, GPS coordinates from GPS 218 are optionally stored alongside the image 117. When the timestamp completes successfully, the image 117, the verifiable timestamp 131 and GPS data are moved to the private image library 280 maintained in memory 215 controlled by the image application 115. In this manner it is not possible to utilize any images that are not taken by the image application 115 directly from the camera 217, or that originate outside of the image application 115, such as by side loading, or downloading.

Once the image application 115 has acquired the image 117 and timestamped the image, the image 117 is ready for further use. After this point, the resultant image 117, metadata 270 and timestamp 131 are secure enough to be handled by systems such as text messaging, email or even placing them on a bulletin board or even placing them on the smartphone's photo album. At that point tamper would be detectable. That image 117 and metadata 270 can be checked for verification. If the user intends to submit or send the image 117 to another party, the image application 115 will collect some information or metadata 270 from the user. The information is preferably identification information, text, or email addresses. The information would correspond to the intended purpose of the image 117 and will be included as image metadata 270.

For example, if the image is destined to be sent to a property rental site, the user would embed a listing website associated with the rental site and listing ID to the image, to show that these images were specifically prepared to be listed on that website. However, if the image was prepared for an auction site, an auction listing ID would be included. An image meant for a dating website would have the website's name and the user's handle or username added. An image being prepared to be sent in an email intended for an individual has the email address of that individual included.

Optionally, the geolocation data could be added to the metadata of the image, or the geolocation data could be fuzzed so that the data only indicates a general location in the vicinity, instead of pinpointing an exact location. This geolocation data could be useful for rental property sites wishing to show where a property is located, but without pinpointing it. The geolocation data also could be useful for a user looking to ensure that the person they are starting online relationship with, actually resides within the geographic area that the person provided. The available options for providing GPS data are 1. No GPS data, 2. Approximate GPS data, and 3. exact GPS data. There is no possibility to add arbitrary GPS data.

Optionally, the image application utilizes the smartphone's user authentication system. The authentication system is usually password based or biometric test based. In either case the authentication system is employed to add authorship and ownership to the images' metadata. Once the image and metadata are ready, more fingerprints (cryptographic hashes) are created to include that metadata along with the image. While the metadata is preferably included with the image as EXIF or other embedded metadata, there is a chance that the destination server for the image will strip the metadata. Due to that, redundant mechanisms are utilized to keep the metadata associated with the image. For example, a dictionary is utilized to keep the image's fingerprint, and the metadata, and that dictionary is stored, and also possibly sent as a text manifest with the image. In addition, an additional timestamp is employed once for each time a new metadata is paired with the image such that each new pairing consists only of the original image and the new metadata, and not any old metadata that was paired prior.

The image application employs cryptographic features of the smartphone, in order to securely transfer the fingerprint, and optionally the metadata dictionary, to the complementary service providing a remote part of this invention, and also allows for the service to vet the image application to ensure that it is the true client software app complement of the system. This feature is important. Preferably the service only receives images and metadata from the real image application, and not a fake application masquerading as the image application. Only an image application that fully complies with the requirements described herein is allowed to submit photographs and metadata to the system. Any other fake application that masquerades as the true image application, could provide fake images and fake metadata. To ensure this, the trusted service will generate a unique request to the image application, the image application will take the unique request, and combine the unique with a smartphone-specific token and sends the result back to the service.

Alternatively, the image application will provide that smartphone-specific token as part of any communication with the system. The service will then extract the token, which is only possible if the connection is secure, and the response is valid and unaltered and will then verify that token with the manufacturer of the smartphone. The manufacturer of the smartphone uses that token to verify the authenticity of the smartphone and image application. If the image application and the smartphone were compromised or the application was invalid, then the verification would fail.

As discussed previously in patent application Ser. No. 16/903,332, incorporated herein by reference, the system provides trusted time and unalterability of the temporal chronology, by creating a secure, and tamper-proof mechanism like a double-ledger accounting system. For example, the system in preferred embodiment the system accepts the fingerprints from the image application, and then accesses a secure clock (from GPS, atomic clock broadcasts, or network time) to get the current time, and enters the time and the fingerprint into a sequential list, that the system then maintains in a secure location. Alternatively, the system combines the trusted time with the fingerprint into a new cryptographic certificate and returns that certificate to the agent for use by the user. The problem with these solutions is that the system has to enclose and maintain the trust, which would need to be proven to users in order to gain their trust in the entire mechanism.

Alternatively, the system only needs to securely take data from the agent and then submit it to other systems that would maintain the trust in an existing sequential chronology of generic postings or transactions. That allows the system to only need to provide a small amount of assurance and would have no access to any alterable system of timestamps and fingerprints storage; thus, the proof of trust is pushed onto another existing, and already trusted, service.

In this latter scenario, there are a number of possibilities: the fingerprints can be sent as Tweets to Twitter, where the fingerprints enter a sequential stream that cannot be altered or reordered. Even more appropriate would be the insertion of the fingerprints into Blockchains as transactions. Blockchains are truly unalterable, and, by design, they are very trusted. This level of trust is gained easily, without much work, by embedding within the Blockchain.

With the successful completion of these steps, the service will provide the app with necessary information to be used for later verification, and the app will now make the trusted image available for use outside the app. It can be “shared” or transmitted in a variety of manners, as is usual with smartphones. (via SMS, Email, WhatsApp, Messenger, HTML upload, etc.)

In order to verify or authenticate a trusted image the system performs the steps described below. The system mentioned above is an essential partner to the image application for the creation of the trusted images. The system, or a subset of the system running independently, is also instrumental for validation and authentication of images. This can be achieved in a number of ways.

For example, when the image is uploaded, along with the metadata, the system makes a fingerprint while modifying the document to include the fingerprint and analyzes the fingerprint against the original fingerprint that is maintained in the trust service, such as, Blockchain. If there is a match, the system indicates success. When the image is provided to an online site, and local processes such as Java or JavaScript code, create a fingerprint locally, the processes communicate the fingerprint to the System for verification, as above. When a URL pointing to the image is provided to the system. The system procures the image, and then creates a fingerprint and verifies it, as above. When the image application mentioned above, or another app, is used to submit a received image, as a fingerprint, to the system and gets verification results back.

All these mechanisms verify the image and provide metadata in a listing, in order to answer some or all queries such as:
Was this image meant for “user@domain.tld”?
Was this image meant for AirBnB.com's listing id 01234567?
Where was this image taken? (GPS could be optional, or with lowered detail)
When was this image taken? (always available)
Was this image taken and signed by the smartphone owner?

A typical use case for these pictures allows a user to upload an image taken and prepared using this invention to a site. The website will then do a verification of the image, as described above, cross referencing any listing or user ID with what is embedded, and then to display the image, adding a recognizable, or distinguishable watermark or overlay, to show that the image has been authenticated. In the case of a failure, the image could be rejected, or it could be displayed with a lack of watermark or overlay, or even with negative symbology indicating a lack of trust.

In order to provide end-to-end image sharing with trust and authentication, the system performs the following. By adding more smartphones to the system, each with the image application installed, this system can provide end-to-end service. One application creates an image, and collects metadata, fingerprints and processes it with the system. That same image application either directly sends the resultant image to another user's smartphone and image application, or the second user receives the image from SMS, Email, WhatsApp, etc., and imports it into the image application. The second user's app verifies the image via the trusted service. Images received, with metadata, are exported to the smartphone's photograph library (and also be authenticated again if the need arises).

Example Scenarios

Users of a vacation rental site or similar service, that requires listers to utilize this the described embodiments, can rest assured that the images they are looking at are authentic, and not stolen and being misrepresented.

Participants on a dating site which requires photographs to be those processed and provided by described embodiments, can be certain that the image of a candidate for a relationship was taken by that candidate, for the specific use on that dating site. Further images sent directly from that person can also be verified to ensure that the photographs are not older photographs being represented as current ones. With the embedding of user IDs, emails or tags, the recipient can verify that the sender wasn't forwarding images that they found of others and representing them as their own. It is not possible for an image that has not gone through this process to pass verification. Submitting a photograph that has gone through this process, by some user that was originally sent to user A, and is now being utilized fraudulently by user B, and sent to user C, will clearly verify as being pictures meant for another user and not user C, and user C will be able to observe that and understand that the photograph is being used inappropriately by user B.

A user takes a photograph of an ongoing event using this invention on their smartphone. The photographs are sent to a news agency. The news agency can verify not only the time and date that the photograph was taken, but also that the photograph is unaltered from the original data that the smartphone's camera recorded, and who the photographer was and where they were located (GPS). If the user wishes to make those photographs exclusive to that agency, the name of the agency can be embedded with the photograph. This can prevent the agency from selling the photographs to another agency, without the latter agency's knowledge of who the image was intended for originally.

A US company wishes to learn about the sourcing of parts for a factory. The company wishes to have photographs sent periodically, showing the flow of raw material and the progress through the supplier's warehouse or processing facility. Instead of flying a trusted employee over, they can hire an untrusted individual local to the facility, not necessarily highly trained, and task the individual to use a smartphone with the image application described above. This individual would then visit the supplier and photograph the required areas and the images would automatically be sent to the US company. The US company can verify the authenticity of the images and the time taken, and the physical location taken, in order to gain confidence in their supplier. This invention would prevent the supplier from sharing images they took a long time before when things were different, or the supplier or the untrusted agent, from using images from another factory and represent them as newly taken images of the supplier's factory.

A user bidding on an auction item can immediately see or verify that the images on the auction page, are embedded with the auction listing ID, and feel assured that those images were not stolen from another auction page.

A site that uses thumbnails for user images or avatars, can automatically use this invention's verification mechanism to check the uploaded photograph and look for required strings, such as the site name and the user's name on that site. If those are found, the image is displayed as the user's avatar, with a checkmark or a special logo, indicating that the image was created for the specific use of that website and that user. Optionally, the site can also make available the verified date the image was taken, in case a recent photograph is more desirable than a dated one. All of this requires that the user utilize a smartphone and the app to take photographs and apply the relevant parts of this invention.

Users who list property for rent on the imaginary site of VacationRentals.com will have to provide images that can be verified by this invention system. The images' timestamps are used to ensure that the photographs are fresh, and the images have to have an embedded listing ID, and the string, “vacationrentals.com”, and not any other property listing ID. Images stolen from elsewhere, or meant for another rental site, or altered, or taken at a different location, will not pass verification or will not match the listing info and would be rejected. Images having embedded string that identify the property differently or with a different listing ID or website, will also be rejected. The only images that would be acceptable are images taken by a smartphone utilizing this invention, with the right metadata.

On dating sites, users' images that have been taken using the smartphone app that utilizes this invention, will be verified upon upload. Those images would then have a badge, or checkmark, indicating that those images are current, authentic, and were taken for use on that site and only that site. Images stolen from other sites, or images stolen from other people, would not be able to achieve a positive verification.

When dating site users communicate with each other and share images created by this system, they would embed each other's email addresses, or user IDs, or handles, in those images. Upon receipt of an image, each user can verify that the image was created specifically for them and was not just an image sent to the first party, by a third party, and then passed off as the first party's own image. In other words, when Jane sends images to Paul, Paul can see that the image has Paul's name, handle, or email, embedded in the picture. This prevents a scammer from scamming another woman for a photograph or stealing a woman's photograph from another site on the Internet and forwarding that image to Paul, as being a photograph of Jane. Jane will have to take a photograph with her smartphone, via this invention's app, and embed the correct info for Paul, in order for Paul to be able to verify that he has received a photograph of the Jane he is communicating with, as sent to him by that Jane. And he can check the trusted date on the photograph to see how long before that photograph was taken.

Having thus described several illustrative embodiments of the present disclosure, those of skill in the art will readily appreciate that yet other embodiments may be made and used within the scope of the claims hereto attached. For example, if one only had the image and not the metadata, one could only check the image for authenticity and date of image acquisition, and not metadata. That prevents any new metadata from being added. This would prove the photograph is real but there is no proof that the photograph truly belongs to the Airbnb listing, or to the dating site member who is using the photograph. Numerous advantages of the disclosure covered by this document have been set forth in the foregoing description.

1. A computer-implemented method to authenticate electronic images sent to a recipient, the method comprising:
obtaining recipient identifying metadata about the recipient;
generating a unique identifier value, from a user device, identifying the user device;
obtaining, prior to any modification, an original electronic document containing an image, directly from a sensor on the user device or from a secure library on the user device and excluding images from any other source;
receiving, by a timestamp and authentication server, an encrypted that indicates the time the image was created;
embedding the recipient identifying information, the unique identifier value, and the encrypted into the electronic document to generate a provably trusted electronic document; and
sending the provably trusted electronic document to the recipient.

2. The computer-implemented method of claim 1, wherein sending the provably trusted electronic document to the recipient includes:
uploading an electronic document to a website,
verifying the electronic document upon upload, and
displaying the document with a visible tag to the electronic document when the electronic document is verified as the provably trusted electronic document and rejecting the electronic document when the electronic document is not verified.

3. The computer-implemented method of claim 1, wherein obtaining recipient identifying metadata includes obtaining at least one of an email address, a physical location address, a username, and description of the recipient.

4. The computer-implemented method of claim 1, further comprising obtaining generalized GPS information associated with the image.

5. The computer-implemented method of claim 1, wherein the user device is a smartphone and further comprising authenticating the user of the smartphone when obtaining the image by requiring a password or biometric test.

6. The computer-implemented method of claim 5, further comprising modifying the provably trusted electronic document to include a cryptographic fingerprint.

7. The computer-implemented method of claim 6, further comprising confirming that the smartphone has not been tampered with by receiving an identifying token from the smartphone.

8. The computer-implemented method of claim 7, further comprising sending the cryptographic fingerprint and identifying token with provably trusted electronic document.

9. The computer-implemented method of claim 8, further comprising verifying provably trusted electronic document by analyzing the cryptographic fingerprint and metadata.

10. An image transport system for generating a provably trusted electronic document containing a secure image comprising:
a user device including an input unit configured to obtain recipient identifying metadata about a recipient, a device identifier for generating a unique identifier value, from the user device, identifying the user device, a camera or a secure library configured to generate an original electronic document containing an image, a transceiver, a memory and a central processing unit, all connected by a communication network,
an application residing in the memory and running on the central processing unit, and
a direct channel extending from the camera or the secure library, directly to the application over the communication network and configured to exclude images from any other source, wherein the application is configured to:
obtain, prior to any modification, an original electronic document containing an image, directly from a sensor on the user device or from a secure library on the user device through the direct channel;
receive, by a timestamp and authentication server, an encrypted that indicates the time the image was created;
embed the recipient identifying information, the unique identifier value, and the encrypted into the electronic document to generate a provably trusted electronic document; and
sending the provably trusted electronic document to the recipient with the transceiver.

11. The image transport system of claim 10, further comprising:
a website configured to:
receive an electronic document,
verify the electronic document upon upload, and
add a visible tag to the electronic document when the electronic document is verified as the provably trusted electronic document and reject the electronic document when the electronic document is not verified.

12. The image transport system of claim 10, wherein the recipient identifying metadata includes obtaining at least one of an email address, a text string, a physical location address, a username, and description of the recipient.

13. The image transport system of claim 10, further comprising a GPS unit configured to obtain generalized GPS information associated with the image.

14. The image transport system of claim 10, wherein the user device is a smartphone and the smartphone further comprises a user interface and a biometric sensor configured to authenticate the user of the smartphone when obtaining the image by requiring a password or biometric test.

15. The image transport system of claim 14, further comprising a cryptographic fingerprint in the image.

16. The image transport system of claim 15, further comprising a token generator in the user device configured to confirm that the smartphone has not been tampered with by receiving an identifying token from the smartphone.
